(19) United States
(12) Patent Application Publication
(10) Pub. No.: US 2009/0197530 A1
(43) Pub. Date: Aug. 6, 2009

(54) Guard tour system utilizing mote networks

(75) Inventors: Dean M. Chriss, Euclid, OH (US); Barry J. Markwitz, Solon, OH (US)

Correspondence Address: James A. Hudak, Esq., Suite #304, 29425 Chagrin Blvd., Cleveland, OH, 44122, US

(73) Assignee: Time Keeping Systems, Inc.

(21) Appl. No.: 12/011,873

(22) Filed: Jan. 31, 2008

(51) Int. Cl. H04B 7/00

(52) U.S. Cl. 455/41.2

(57) ABSTRACT

A guard tour system utilizing mote networks is disclosed. The system includes a web browser, a server and a plurality of motes in a network which communicate with one another using radio frequency communication. The motes have media readers associated therewith permitting the identification of guard tour officers and incident identifiers to be read from various types of media. The motes transmit guard tour data to the server via a radio frequency transceiver or a communication interface for analysis, reporting, notification or other purpose. Pre-existing mote networks can be utilized thus reducing the number of motes required for communication with the server or other computer utilized by the guard tour system.

### TECHNICAL FIELD

The present invention relates, in general, to guard tour systems and, more particularly, to guard tour systems that utilize mote networks.

### BACKGROUND ART

Most currently available guard tour systems utilize portable data collection devices that are carried by officers on patrol. These portable data collection devices are used to gather tour data, which are stored in the memory of the portable data collection device until the data can be transferred to a computer for analysis and reporting purposes. This transfer of data typically occurs in a batch at the end of a shift, when the memory of the portable data collection device becomes full, or at another convenient time.

A tour typically starts when a guard reads his or her identifier from a barcode, magnetic stripe, or other device or media, using a portable data collection device. The portable data collection device stores the guard's identifier, along with a timestamp provided by a real time clock within the portable data collection device, in the memory of the portable data collection device. While on a tour, the guard carries the portable data collection device and uses it to read and timestamp data from checkpoints at predetermined tour locations. These checkpoints may also utilize barcodes, magnetic stripes, or other devices or media to provide the data to be recorded. Regardless of the type of data providing device or media utilized, each checkpoint has a unique identifier that can be associated with the location of the data providing device or media. If incidents occur during a tour, the guard again uses the portable data collection device to read and timestamp the data that corresponds with each incident. The result is a list of data and timestamp pairs within the memory of the portable data collection device that define the guard's activity during the course of a tour or guard shift. The collected data are then transferred to a computer for analysis and reporting purposes when the tour or shift is finished or when the memory in the data collection device is full or at another convenient time. After the data have been successfully transferred to the computer, the portable data collection device is cleared of its data.

Because the data collected by the portable data collection device are often of a critical nature to a business or law enforcement facility, the device must maintain the integrity of the tour data it contains, even when the device is subjected to accidental or deliberate abuse. This is a failing of many portable data collection devices because it is inherently difficult to make portable battery powered electronic devices having sufficient durability. In addition, because portable data collection devices can carry a large volume of tour data that has been collected but not yet transferred to a computer, damage to the device can result in the loss of a significant amount of data. Furthermore, since collected data are stored only within the portable data collection devices until periodic transfer to the computer occurs, guard tour activity occurring since the last data transfer is not available for analysis and reporting purposes.

In view of the inherent problems associated with the use of portable data collection devices for guard tour systems, it has become desirable to develop a guard tour system that does not require such devices.

### SUMMARY OF THE INVENTION

The present invention solves the problems associated with using portable data collection devices in guard tour systems, and other problems, by using mote networks, thus eliminating the need for such portable data collection devices. Mote networks embody unique sensor network architecture because they combine sensing devices with very small computers, called motes. Motes are battery powered and communicate via a very low power wireless connection with every other mote that is within communication range. This ability permits any mote to communicate with a distant server or other computer through intermediate motes. It also provides a robust network because multiple communication paths can be available to any particular mote.

In the present invention, one or more mote networks are utilized to transmit guard tour data to an associated computer for analysis, reporting, notification, or other purpose. The present invention can utilize pre-existing mote networks, thus reducing the number of motes required for communication with the server or other computer utilized by the guard tour system software.

### BRIEF DESCRIPTION OF THE DRAWINGS

FIG. 1 is a schematic diagram of the guard tour system of the present invention utilizing mote networks.

FIG. 2 is a schematic diagram of a typical mote utilized by the present invention.

FIG. 3 is a schematic diagram of the gateway mote utilized by the present invention.

### DESCRIPTION OF THE PREFERRED EMBODIMENT

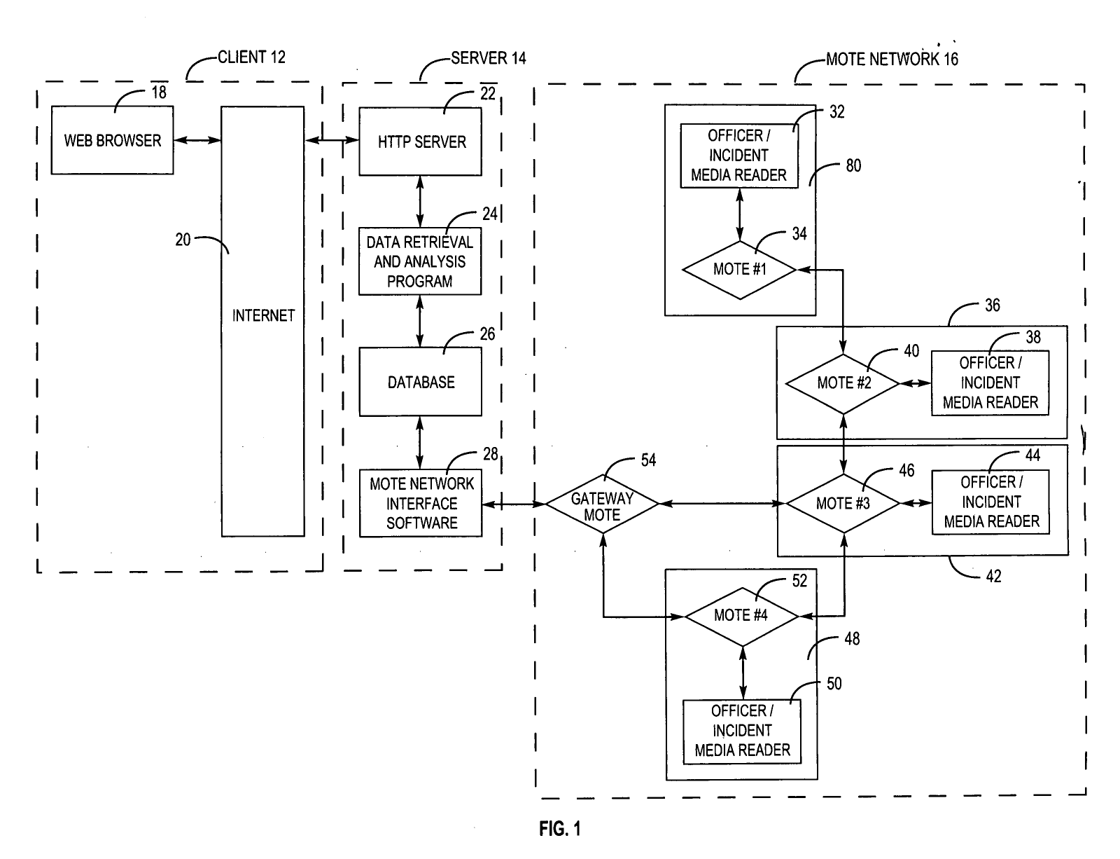

Referring now to the drawings where the illustrations are for the purpose of describing the preferred embodiment of the present invention and are not intended to limit the invention described herein, FIG. 1 is a schematic diagram of the guard tour system 10 of the present invention utilizing mote networks. The guard tour system 10, as illustrated, includes a client, shown generally by the numeral 12, a server, shown generally by the numeral 14, and a mote network, shown generally by the numeral 16. The client 12 includes a web browser 18 capable of accessing the Internet 20. The server 14 includes an HTTP server 22, a data retrieval and analysis program 24, a database 26 and mote network interface software 28.

The mote network 16 utilizes mote enabled readers 30, 36, 42 and 48, each of which consists of a media reader 32, 38, 44 and 50, respectively, capable of reading officer and incident identifiers that are used by the guard tour system 10. The media readers 32, 38, 44, and 50 are connected to motes 34, 40, 46 and 52, respectively. Officer and incident identifiers may be barcodes, magnetic stripes, RFID tags or other media or devices capable of containing the identifiers.

The mote enabled readers 30, 36, 42 and 48 are placed at predetermined locations that guards visit along the guard patrol route. The motes 34, 40, 46, 52 and 54 automatically establish a wireless connection with each other and with any pre-existing motes that are within communication range. The only requirement is that each mote 34, 40, 46, 52 and 54 be within the communication range of at least one other mote in the network 16. If locations that a guard must visit are further apart than the communication range of the motes 34, 40, 46, 52 and 54, additional motes can be placed so that each mote is within the communication range of at least one other mote.

The centrally located server 14 or another computer is used to collect and analyze data from the mote network 16. Connection between the server 14 or other computer and the mote network 16 is via a wired or wireless connection to a mote 54 of the mote network 16, utilizing a communication interface, which is present in all motes 34, 40, 46, 52 and 54. The mote to which this connection is made is known as the gateway mote, which may also have a reader attached thereto. The gateway mote can be any mote of the mote network 16, but it is typically the mote that is in closest proximity to the server 14 or other computer used to collect and analyze data. Mote network interface software 28 executing within the server 14 or other computer handles the interface with the mote network 16. This software 28 is responsible for receiving guard tour data from the mote network 16 and storing the data in the database 26. Data stored in the database 26 by the mote network interface software 28 are immediately available to the data retrieval and analysis program 24 which is also executing within the server 14 or other computer. In a single user system, the program 24 would make guard tour data available directly to the user by means of reports and displays. In the system 10 illustrated in FIG. 1, such reports and displays are made available to multiple users by means of web browsers 18 which communicate with the server 14 by means of the Internet 20. HTTP server software 22 executing within the server 14 handles the interface between the multiple web-based users and the data retrieval and analysis program 24 within the server 14.

It should be noted that different system architectures are possible, or even desirable, depending on the installation. For example, access for multiple users could be provided by a local or wide area network (LAN or WAN) instead of the Internet 20. Similarly, the web browser 18 could be replaced with client software to access data via a LAN or WAN instead of the Internet 20 directly from the database 26 or from the data retrieval and analysis program 24. In another alternative for larger installations the HTTP server software 22, data retrieval and analysis program 24, database 26 and mote network interface software 28 could each reside on separate computers.

When the guard visits locations during the course of a tour, the guard reads his or her identifier using the mote enabled reader 30, 36, 42, 48. Software within the mote 34, 40, 46 and 52 associated with the media reader 32, 38, 44, 50, respectively, provides a timestamp and an identifier unique to the mote enabled reader 30, 36, 42, 48, and its location. The guard identifier, mote enabled reader identifier, and timestamp are then transmitted via the mote network 16 to the server 14 or other computer where the data are stored in database 26, as previously described.

If incidents occur during the course of a guard's patrol, the guard reads identifiers corresponding to the incidents using the nearest mote enabled reader 30, 36, 42, 48. Software within the mote 34, 40, 46, 52 associated with the media reader 32, 38, 44, 50, respectively, provides a timestamp and an identifier unique to the mote enabled reader 30, 36, 42, 48, and its location. The incident identifier, mote enabled reader identifier, and timestamp are then transmitted via the mote network 16 to the server 14 or other computer where the data are stored in the database 26, as previously described.

Data that are stored in the database 26 are sufficient for the data analysis and retrieval program 24 to determine which guards visited each location and when each visit was made. Incident data stored in the database 26 are sufficient for the data analysis and retrieval program 24 to determine which incidents occurred at or near each location and when each incident was reported. This information can be made available to users almost immediately while the guard is still at or near the last reported location. This availability of information has obvious advantages when compared with guard tour systems utilizing typical portable data collection devices.

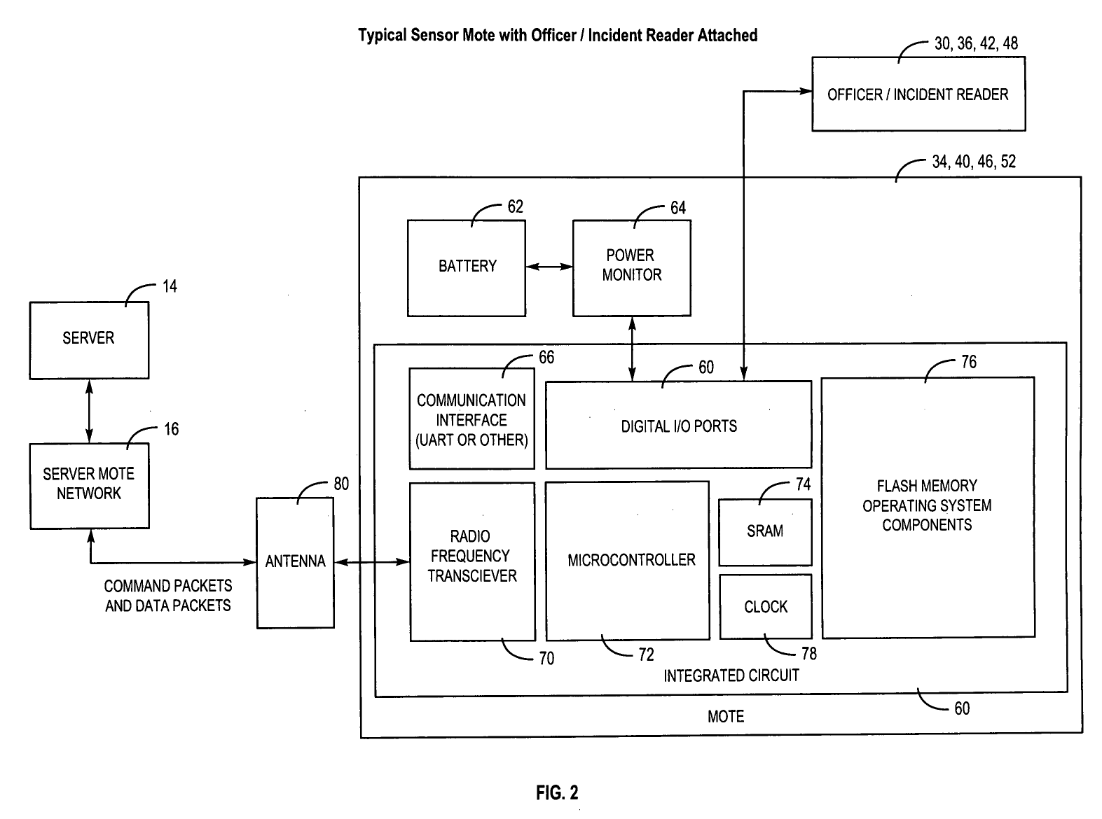

A schematic diagram of a typical mote 34, 40, 46, and 52 is illustrated in FIG. 2. As shown, each mote 34, 40, 46, and 52 is comprised of an integrated circuit 60, a battery 62 and a power monitor 64. The integrated circuit 60 includes a communication interface 66, digital input/output ports 68, a radio frequency transceiver 70, a processor 72, a SRAM 74, a flash memory 76, and a clock 78. The flash memory 76 stores the operating system and associated programs of the mote, which are executed by the processor 72 utilizing the SRAM 74 and the clock 78. The operating system and the associated programs monitor the digital input/output ports 68 and transmit corresponding data to the server 14 via the radio frequency transmitter 70 within the mote and antenna 80. The operating system and associated programs also handle other functions such as relaying communications to and from other motes 34, 40, 46, 52 and 54 of the mote network 16, and providing output signals as appropriate to connected devices via the digital input/output ports 68.

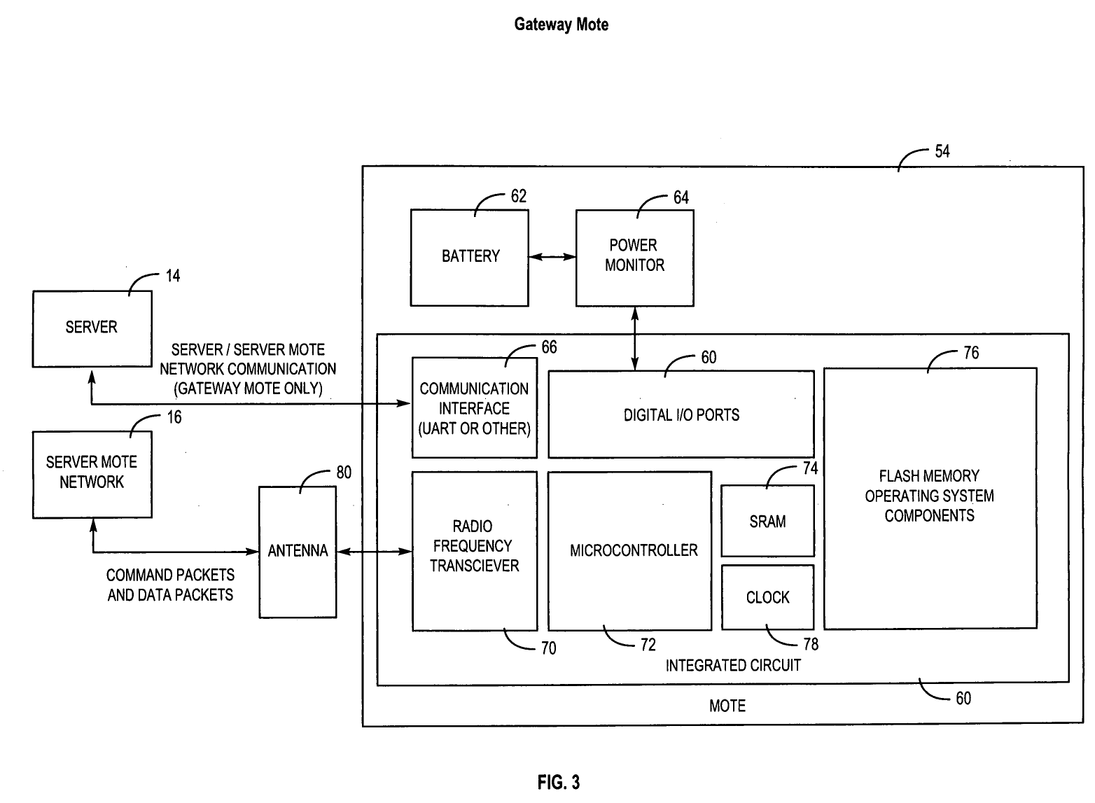

The battery 62 provides power for the operation of the integrated circuit 60 and its associated circuitry. A power monitoring circuit 64 monitors battery condition and provides data indicating battery condition as an input to the digital input/output ports 68 which are monitored as previously described. If the mote involved is not mote 54, the data indicating the battery condition is transmitted, to the server 14 via the radio frequency transmitter 70 within the mote and antenna 80. If the mote involved is mote 54, the data indicating the battery condition is transmitted to the server 14 via the communication interface 66 within the mote, as shown in FIG. 3.

Data from a media reader 32, 38, 44, or 50 is inputted to the digital input/output ports 68 which are monitored by the operating system and associated programs of its mote, as previously described. The data are processed and time stamped by the operating system and associated programs of the mote using the clock 78. The time stamped data are subsequently transmitted to the server 14 via the radio frequency transmitter 70 within the mote and antenna 80 if the mote involved is not mote 54, as shown in FIG. 2. If the mote involved is mote 54, the time stamped data are transmitted to the server 14 via the communication interface 66 within the mote, as shown in FIG. 3. The operating system and associated programs of the mote provide output signals as appropriate to the media reader 32, 38, 44, or 50 indicating the success or failure of the read operation. Depending on the design of the reader, this signal can cause the reader to illuminate an LED or emit a sound to indicate a successful read to the guard on patrol.

A schematic diagram of the gateway mote 54 is illustrated in FIG. 3. As shown and as previously described, the gateway mote 54 is identical to the other motes 34, 40, 46, 52, but it is also connected by a wired or wireless connection directly to the server 14. The gateway mote 54 is the only mote of the mote network 16 with such a connection, and it is the mote through which all traffic of the mote network 16 is routed.

Certain modifications and improvements will occur to those skilled in the art upon reading the foregoing. It is understood that all such modifications and improvements have been deleted herein for the sake of conciseness and readability, but are properly within the scope of the following claims.

We claim:

1) A guard tour system comprising a computer device, at least one mote device, means for connecting said at least one mote device with said computer device, and at least one media reader capable of reading guard tour identifiers connected to said at least one mote device.

2) The system as defined in claim 1 wherein said at least one mote device comprises a plurality of mote devices capable of communicating with one another through radio frequency communication.

3) The system as defined in claim 1 wherein said at least one mote device includes means for communicating with said computer device and said computer device includes an interface permitting communication between said computer device and said at least one mote device.

4) The system as defined in claim 3 wherein said communicating means comprises a radio frequency transceiver.

5) The system as defined in claim 3 wherein said communicating means comprises a hard wired communication interface.

6) The system as defined in claim 1 wherein said computer device can be accessed by a client computer device.

7) The system as defined in claim 6 wherein access of said computer device by said client computer device is by means of the Internet.

8) The system as defined in claim 6 wherein access of said computer device by said client computer is by means of a local area network (LAN).
